(19) United States
(12) Patent Application Publication
(10) Pub. No.: US 2025/0131164 A1
(43) Pub. Date: Apr. 24, 2025

(54) Network route optimization using Digital Twin (DT) emulation

(71) Applicant: Ciena Corporation, Hanover, MD (US)

(72) Inventors: Christopher Ryan Barber, Ottawa (CA); David Jordan Krauss, Centreville, VA (US); Mohamed Zalat, Ottawa (CA); Thomas Kunz, Ottawa (CA); Babak Esfandiari, Ottawa (CA); Thomas Triplet, Manotick (CA)

(73) Assignee: Ciena Corporation, Hanover, MD (US)

(21) Appl. No.: 18/525,450

(22) Filed: Nov. 30, 2023

Related U.S. Application Data
(60) Provisional application No. 63/591,746, filed on Oct. 19, 2023.

(51) Int. Cl. G06F 30/27; G06F 111/06

(52) U.S. Cl. CPC G06F 30/27; G06F 2111/06

(57) ABSTRACT

Systems and methods include managing a Network Digital Twin (NDT) for a network, the NDT including an emulation model and an optimization model, wherein the emulation model is configured to emulate the network and the optimization model is configured to determine configuration changes to the network based on a cost function; performing an iterative procedure with the optimization model and the emulation model to determine one or more configuration changes to the network based on the cost function; and providing the one or more configuration changes from the iterative procedure for use in the network, where the one or more configuration changes address the cost function.

### CROSS-REFERENCE TO RELATED APPLICATION(S)

The present disclosure claims priority to U.S. Provisional Patent Application No. 63/591,746, filed Oct. 19, 2023, the contents of which are incorporated by reference in their entirety.

### FIELD OF THE DISCLOSURE

The present disclosure relates generally to networking and computing. More particularly, the present disclosure relates to systems and methods for network route optimization using Digital Twin (DT) emulation.

### BACKGROUND OF THE DISCLOSURE

Traffic flow through large communication networks constantly changes. To maintain the performance of communication networks during these traffic flow changes, an expert (e.g., network operator, network management administrator, technician, etc.) usually must take a significant amount of time to manually modify the current network configurations to keep up with the constant changes in network traffic flows. Failure to do so may result in outages and downtime in the network or simply sub-optimal operation, leading to increased costs. To address this, Traffic Engineering (TE) is employed to optimize configurations of the network for maximum network performance and minimal traffic congestion. Thus, many researchers have proposed TE techniques to quickly identify optimal configurations for current network states instead of relying on heuristics often used by experts.

### BRIEF SUMMARY OF THE DISCLOSURE

The present disclosure is directed to systems and methods for optimizing (or at least improving) a communication network, utilizing a Network Digital Twin (NDT) that includes a combination of an optimization model and an emulation model. The emulation model is configured to emulate the network and the optimization model is configured to determine configuration changes to the network to improve a cost function. Advantageously, the approach described herein significantly reduces the time required to optimize network configurations, i.e., addressing a cost function that allows the network routes to be optimized based on link utilization and QoS metrics such as loss, delay, and jitter, as well as any and all combinations thereof. The objective is to make network optimization something performed often, including continuously, to operate the network as efficiently as possible.

In various embodiments, the present disclosure includes a method having steps, an apparatus with a processing device configured to implement the steps, and a non-transitory computer-readable medium storing instructions that, when executed, cause one or more processors to execute the steps. The steps include managing a Network Digital Twin (NDT) for a network, the NDT including an emulation model and an optimization model, wherein the emulation model is configured to emulate the network and the optimization model is configured to determine configuration changes to the network based on a cost function; performing an iterative procedure with the optimization model and the emulation model to determine one or more configuration changes to the network based on the cost function; and providing the one or more configuration changes from the iterative procedure for use in the network, where the one or more configuration changes address the cost function.

The steps can further include sub-steps for the iterative procedure of imposing network modifications to the emulation model; observing behavior changes in the emulation model in response to the network modifications, and repeating the imposing and observing sub-steps to detect an improved network status until a predetermined stopping criteria. The managing the NDT can include a step of training the emulation model using topology information, route information, and traffic flow information, for the network, and updating the training responsive to any implementation of the one or more configuration changes in the network. The steps can further include automatically causing implementation of the one or more configuration changes in the network. The emulation model can include a Graph Neural Network (GNN) and the optimization model includes a genetic algorithm.

The optimization model can include a genetic algorithm that includes the steps of randomly generating a population of potential solutions for optimizing traffic flow, using a fitness function, based on the cost function to evaluate a score for each potential solution, selecting the potential solutions with the highest scores, randomly combining one or more pairs of potential solutions with the highest scores to create a new population, randomly modifying the new population to produce modified solutions, replacing old solutions with the modified solutions, and repeating until a predetermined stopping criteria is reached.

The cost function can be based on one of latency, loss, jitter, link utilization, cost, security, and a combination thereof. The cost function can be based on a plurality of factors combined in a weighted manner to provide a single cost function for the optimization model. The one or more configuration changes each can include one of Open Shortest Path First (OSPF) configuration, Intermediate System-Intermediate System (IS-IS) configuration, Traffic Engineering (TE) tunnel configuration, Border Gateway Protocol (BGP) configuration, link coloring configuration, Resource Reservation Protocol-Traffic Engineering (RSVP-TE) configuration, Multiprotocol Label Switching (MPLS) configuration, Quality of Service (QOS) configuration, and Segment routing configuration.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram illustrating an example of a portion of a communication network having a specific topology, according to one embodiment.

FIG. 2 is a block diagram illustrating a management device for monitoring a communication network, according to one embodiment.

FIG. 3 is a diagram illustrating interactions between an embodiment of the network optimizer shown in FIG. 2 and the communication network of FIG. 1, according to one embodiment.

FIG. 4 is a diagram illustrating an initial training process for training the emulation model shown in FIG. 3, according to one embodiment.

FIG. 5 is a diagram illustrating interactions between the emulation module of FIG. 4 and the optimization model shown in FIG. 3, according to one embodiment.

FIG. 6 is a flow diagram illustrating a method for optimizing a communication network, according to one embodiment.

FIGS. 7A-7C are graphs showing results of testing the performance of the network optimizer shown in FIG. 2.

### DETAILED DESCRIPTION OF THE DISCLOSURE

In the context of Traffic Engineering (TE) in communication networks, such as Internet Protocol (IP) networks, the Open Shortest Path First (OSPF) configuration of a network is often based on the expected or measured link latency of the network. In the present disclosure, optimization techniques are introduced using a Digital Twin (DT) of the network that can modify the network configuration in order to optimize some cost function. For example, the network configured can include OSPF configurations as well as various other configurations as described herein, with the OSPF configurations and the various other configurations investigated individually and in combination with one another. The cost function can be any of link weights (link costs), IP Quality of Service (QOS) metrics, and combinations thereof.

For illustration purposes, some descriptions here focus on using the OSPF configurations and changes thereto to optimize the cost function, and those skilled in the art will appreciate this is one example and practical embodiments can use any configuration, in any combination. This is an advantage of machine learning and the digital twin-it is possible to investigate any configuration changes to obtain improvements in the cost function, including configuration changes not necessarily apparent to a human operator, but available to machine learning. Also, it should be noted that the term “optimization” and other similar terms used herein are meant to imply an improvement in a system toward a more optimized or optimal solution and does not necessarily imply an ultimately achieved ideal state.

For OSPF configuration, the problem with finding an optimal OSPF configuration for a given topology and a set of traffic flows/demands can be an NP-hard problem. The optimization involves setting the Interior Gateway Protocol (IGP) metric of each link in the network to optimize the traffic flow in the network based on some desired criteria. The IGP metric of a link in the OSPF protocol, also referred to as the weight of the link, is the cost of taking this link. Traffic flowing to a destination node from a source node is routed through the minimal-cost path. Usually, the initial step for any OSPF network is to either: 1) set all metrics to an equal weight to minimize hops, or 2) set all metrics to an approximation or measured delay of the links to allow OSPF to minimize flow latency. The issue with this is that flows no longer account for utilization and links can congestion (therefore interrupting optimal latency).

Generally, OSPF optimization requires an exploration over different configurations of IGP metrics until some cost function is minimized or at least reduced. This exploration is usually performed by conventional systems on a simulation based on the real network to test each new configuration. The new configuration which results in the lower overall cost is then applied to the real network. The problem with using these types of simulations for this task is that they are often prohibitively slow, taking hours or days to explore enough “what if” scenarios to find a better configuration, which may not even be optimal. A rigorous exploration of the OSPF configuration space would be more likely to find an optimal solution than manual exploration by network operators.

Often, to test “what if” scenarios, network planners will use network simulations. They generally iterate either manually through trial and error or in a brute-force (exhaustive scenario) search over several network configurations until they find a configuration which improves the performance of the network. There are also other studies which use ML-based approaches to find the OSPF configuration which minimizes the total network utilization or the maximum link utilization. It may be noted that, in addition to OSPF configurations, those skilled in the art will recognize other network configurations are contemplated.

Again, network simulations for testing what-if scenarios tend to be very slow, taking hours to days to run (especially ones that do an exhaustive scenario search). With simulation approaches, relatively few scenarios can be tested, so often the stopping criterion is based on the time to run the simulation. In this case, the new configuration might be far from the optimal solution. In addition, other ML-based solutions which optimize the OSPF configuration, optimize based on link utilization without considering Quality of Service (QOS) metrics and thus may negatively impact traffic delays.

Therefore, the present disclosure relates to systems and methods for network route optimization using Digital Twins, which are configured to overcome deficiencies of the conventional systems. A “digital twin” is a digital representation of a network, contextualized in a digital version of its environment and the digital twin is used to simulate real situations and their outcomes, ultimately allowing it to make better decisions.

Variously, the present disclosure may further include a Network Digital Twin (NDT) for route optimization in Internet Protocol (IP) networks, in which:

(1) The optimization includes minimizing a cost function which depends on QoS metrics, which can include any combination of (a) maximum or average latency, (b) maximum or average loss, (c) maximum or average jitter, (d) maximum or average link utilization, (e) maximum or average dollar cost of links traversed, (f) security posture of the network (where link metrics are an expression of relative security), and the like.

(2) The network digital twin may include:
(a) an emulation model to simulate a network, such as a Graph Neural Network (GNN)-based ML model which takes as input the physical network topology, routes, and traffic flows, and outputs metrics required to compute the cost function, such as QoS metrics. An example of a model which fulfills this criteria is RouteNet-Fermi, also known as RouteNet-F, which is a GNN model of a communication network proposed by the same authors of TwinNet, Ferriol-Galmés et al., see M. Ferriol-Galmés, J. Paillisse, J. Suárez-Varela, K. Rusek, S. Xiao, X. Shi, X. Cheng, P. Barlet-Ros, A. Cabellos-Aparicio, RouteNet-Fermi: Network modeling with graph neural networks, IEEE/ACM Transactions on Networking (2023), the contents of which are incorporated by reference in their entirety.
(b) an optimization model such as an optimizer which iterates over different network configuration candidates, testing each configuration using the GNN-based ML model and finding the configuration which minimizes the cost function. The optimizer includes (i) a genetic algorithm, or (ii) any other optimization algorithm.

(3) The specific network configuration, which is modified in the network digital twin, may include
OSPF configurations of Interior Gateway Protocol (IGP) metrics on each link
IS-IS configurations of IGP metrics on each link
TE tunnels
Border Gateway Protocol (BGP) configurations
Link coloring and associated policy
Resource Reservation Protocol-Traffic Engineering (RSVP-TE) configurations
Multiprotocol Label Switching (MPLS) configurations
QoS configurations via IP Type of Service (ToS) bits, MPLS Experimental (EXP) bits
Segment Routing configurations.
Any other network configuration which affects IP traffic routes, QoS policy configuration or Traffic Engineering policy configuration.
Any and all combinations of the above.

(4) A process to apply the new configuration back into the physical network, namely to implement any suggested configuration changes from the network digital twin, whether autonomously implemented, manually implemented, continually implemented, periodically implemented, etc.

Rusek et al. proposed Routing by Back-propagation (RBB): a technique that uses a Graph Neural Networks (GNN) trained to approximate Dijkstra's algorithm to find an Open Shortest Path First (OSPF) configuration that minimizes the maximally utilized link. On the other hand, TE methods use local search heuristics to find an OSPF configuration that minimizes the total network utilization and the maximum link utilization respectively. However, optimizing the OSPF configuration based on link utilization does not consider Quality of Service (QOS) metrics and may negatively impact traffic delays.

In recent work, Ferriol-Galmés et al. proposed using a GNN model of a network simulator called TwinNet that predicts traffic QoS metrics for TE. They use TwinNet to find traffic routes that meet the QoS requirements for each traffic flow, independent of the OSPF configuration. The present disclosure also introduces an OSPF optimization technique that considers QoS metrics. Using a Network Digital Twin (NDT) model, we can produce architectures capable of optimizing the OSPF configuration of a network for the QoS metrics of their choice, as well as for any cost function including weighted combinations of multiple costs.

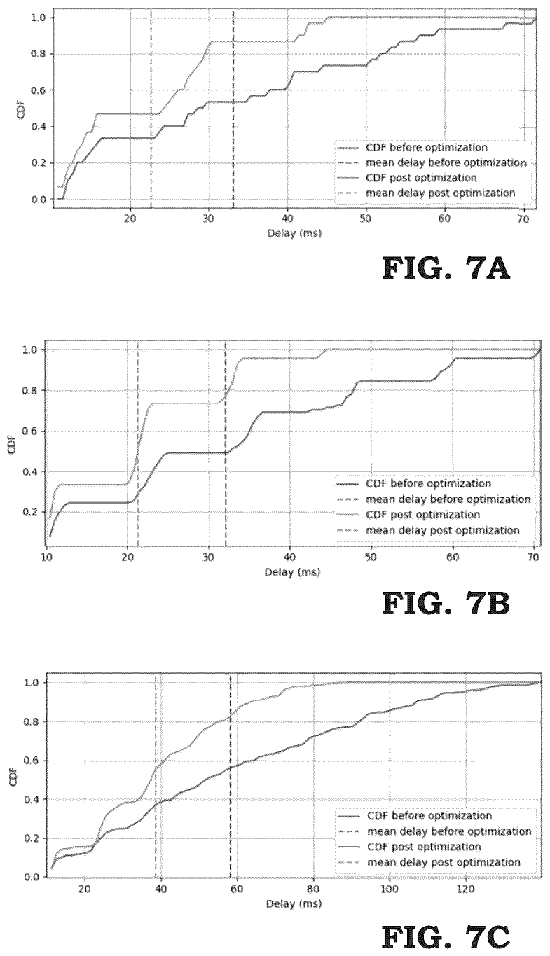

The embodiments of the present disclosure improve upon the techniques of the prior solutions. Today, network optimization is something performed sporadically with significant human involvement. The approach described herein moves toward complete autonomous network control where changes can be made on the fly, continuously. This is due to the significant speed increases in the analysis using the techniques described herein. As described below with respect to FIGS. 7A-7C, the improvements are demonstrated based on testing the novel implementations described herein. In particular, the systems and methods include a process in which 1) network information is applied to an optimization model, whereby the network information includes a current status of an existing network. Next, the process performs an iterative procedure involving the optimization model and an emulation model configured to emulate the existing network. For example, according to various embodiments of the present disclosure, the iterative procedure includes the sub-steps of a) imposing network modifications to the emulation model, b) observing behavior changes in the emulation model in response to the network modifications, and c) repeating the imposing network modifications and observing sub-steps to detect an improved network status. Also, the process includes producing outputs related to the improved network status that can be used to improve traffic flow of the network.

### Network Topology

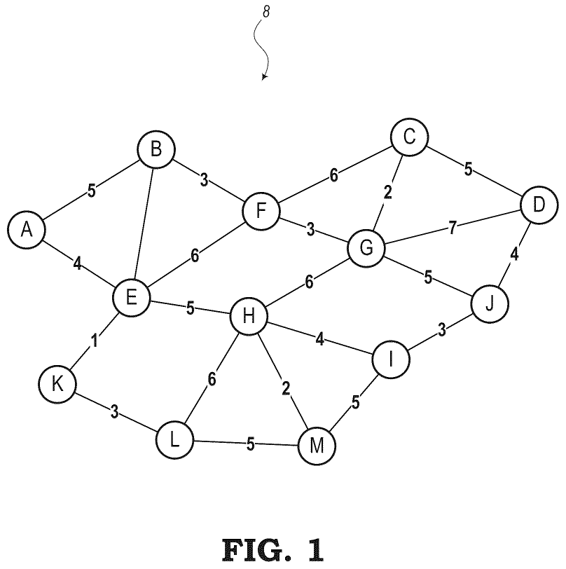

FIG. 1 is a diagram showing an example of a section (e.g., domain) of a network 8, such as a communications network. As shown in FIG. 1, the network 8 includes a plurality of nodes (e.g., Node A, Node B, . . . Node M) having a specific topology. The network 8 includes a plurality of links or edges between various adjacent pairs of nodes. Also, each link included in the network 8 is associated with a specific weight or cost of transmitting data packets along the link. The weight (or cost) can be related to any parameter or combination of parameters associated with network performance. As an example, the weight of the A-B link between Node A and Node is designated as “5” in this case and may include any suitable units of measure based on the parameters being considered or even a relative value that can be used as a simple comparison of one link with another. For example, the weights may be associated with latency or delay (e.g., in milliseconds), data loss (e.g., number of packets, percentage of packets, etc.), jitter (e.g., in milliseconds), operational costs (e.g., in dollars), etc. In some cases, the weights may be variable and may be dependent on various network parameters, such as link utilization, real-time data traffic congestion, node faults, link faults, etc.

### Management Device

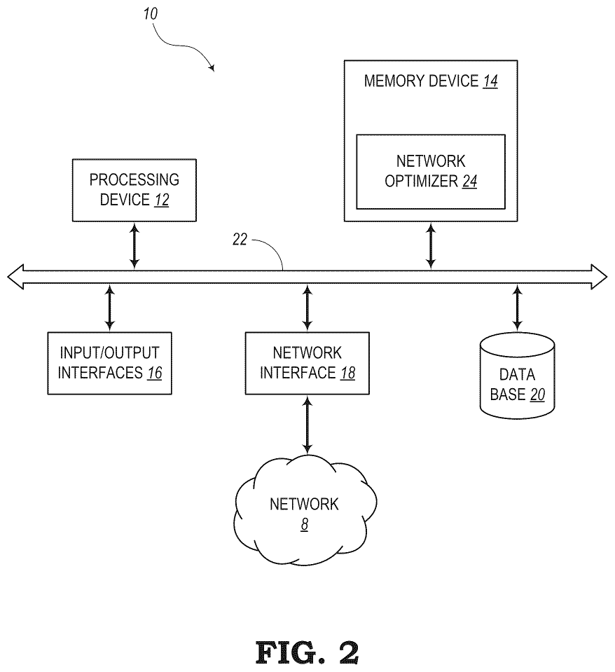

FIG. 2 is a block diagram illustrating an embodiment of a management device 10 for monitoring a network (e.g., network 8). The management device 10 may be associated with a Network Management System (NMS), Network Operations Center (NOC), etc. and may be used by a user (e.g., network operator, admin, technician, etc.). In particular, the management device 10 can be any of a NMS, an Element Management System (EMS), a network planning system, a Software Defined Networking (SDN) controller, an SDN application, an orchestrator, etc.

In the illustrated embodiment, the management device 10 may be a digital computing device that generally includes a processing device 12, a memory device 14, Input/Output (I/O) interfaces 16, a network interface 18, and a database 20. It should be appreciated that FIG. 2 depicts the management device 10 in a simplified manner, where some embodiments may include additional components and suitably configured processing logic to support known or conventional operating features. The components (i.e., 12, 14, 16, 18, 20) may be communicatively coupled via a local interface 22. The local interface 22 may include, for example, one or more buses or other wired or wireless connections. The local interface 22 may also include controllers, buffers, caches, drivers, repeaters, receivers, among other elements, to enable communication. Further, the local interface 22 may include address, control, and/or data connections to enable appropriate communications among the components 12, 14, 16, 18, 20.

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, at least one processor, circuit/circuitry, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by one or more processors (e.g., any type of programmable circuitry or logic) that, in response to such execution, cause the one or more processors to perform a set of operations, steps, methods, processes, algorithms, functions, techniques, etc. as described herein for the various embodiments.

Furthermore, the management device 10 includes a network optimizer 24, which may be configured to determine configurations for optimizing (or at least improving) the network 8. The network optimizer 24 may be implemented in any suitable combination of hardware (e.g., in the processing device 12) and software/firmware (e.g., in the memory device 14). For example, the network optimizer 24 may be stored as computer logic in a non-transitory computer-readable medium (e.g., the memory device 14), where the computer logic may include code or instructions for enabling or causing the processing device 12 to perform certain functionality, such as optimizing (i.e., improving) the configurations and/or operations of the network 8.

In other embodiments, the network optimizer 24 can be implemented via any known computing techniques, including Software-as-a-Service, via the cloud, through Virtual Machines (VMs), via a cluster of servers, etc. That is, the single digital computing device in FIG. 2 is merely one example and those skilled in the art will appreciate the network optimizer 24 and associated functionality contemplate any known compute resources for execution thereof.

### Network Optimization

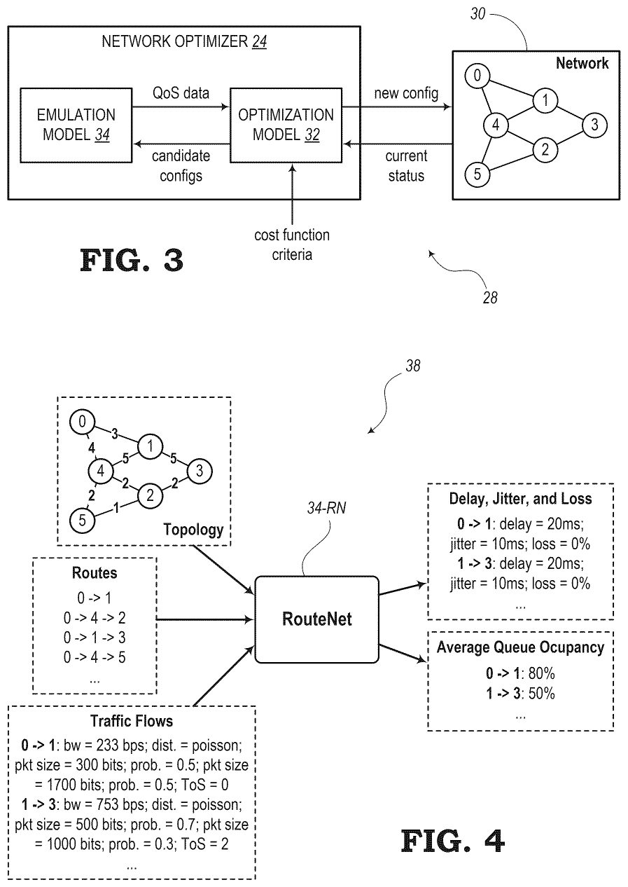

FIG. 3 is diagram illustrating an embodiment of a system 28 in which the network optimizer 24 is configured to interact with a network 30 (e.g., network 8). In this embodiment, the network optimizer 24 includes an optimization model 32 and an emulation model 34. Again, we are referred to the Network Digital Twin (NDT) as being a combination of the optimization model 32 and the emulation model 34. In operation, information regarding a current status of the network 30 is provided to the optimization model 32 of the network optimizer 24. For example, the current status information may include topology information of the network 30, such as information about the nodes, links, and weights (costs).

According to various embodiments, the optimization model 32 and emulation model 34 may be configured as any suitable types of Machine Learning (ML) models. For example, the optimization model 32 may be configured as a “genetic” model and the emulation model 34 may be configured as a Graph Neural Network (GNN), such as RouteNet, RouteNet-Fermi, RouteNet-F, etc.

Once the current network status information is received in the network optimizer 24, the optimization model 32 and emulation model 34 are configured to perform an iterative procedure, providing data back and forth, in order to determine an optimized (improved) configuration for the network 30. However, instead of operating on the real network itself, the optimization model 32 is configured to utilize the emulation model 34. In some embodiments, the system 28 may be considered as having an architecture for Open Shortest Path First (OSPF) optimization. The optimization model 32 may be configured to perform a genetic algorithm, as described in more detail below, or other suitable OSPF optimization techniques.

For example, the iterative procedure may include multiple rounds, generations, or iterations where the optimization model 32 provides suggested candidate configuration changes to the emulation model 34 and then observe how the emulation model 34 responds. The output of the emulation model 34 is provided back to the optimization model 32, for example, as Quality of Service (QOS) data, such as delay, loss, and jitter information. From this QoS data, the optimization model 32 can try multiple candidate configurations, tweak previous configurations, etc. and determine one or more new configurations that will improve (or optimize) the virtual network that is emulated by the emulation model 34. Then, the optimization model 32 is configured to perform any suitable post-processing steps in response to determining improved configurations. For example, one step may include applying a newly discovered configuration improvement directly to the network 30 itself to automatically reconfigure the real network 30. In other embodiments, the optimization model 32 may output suggestions, instructions, recommendations, etc. to the user of the management device 10 for describing how the network 30 can be improved (e.g., by changing traffic routes, by adding new links between existing nodes, etc.).

Again, the present disclosure is described with reference to optimizing OSPF configurations of IGP metrics on each link. Those skilled in the art will recognize the approach described herein contemplates other configurations, e.g., TE tunnels, BGP configurations, link coloring and associated policies, RSVP-TE configurations, MPLS configurations, QoS configurations via IP ToS bits, MPLS EXP bits, Segment Routing configurations, as well as any other network configurations which affect IP traffic routes, QoS policy configuration or Traffic Engineering policy configuration. Also, as used herein, the terms optimization, optimize, minimize, maximize, etc. do not have to reflect a perfect case or value, but rather imply some improvement from a current state.

In one embodiment, the use of a RouteNet-F model for the emulation model 34 may be configured to overcome the issue of simulation speed. This model includes a machine-learning based approach to predict the network QoS metrics for a given network configuration. This approach can be hundreds of times faster than using a simulation.

With the improved iteration speed, the embodiments described herein can make use of optimization algorithms to find the optimal configuration which minimizes the cost function. In this case, the optimization model 32 may include a Genetic Algorithm to iteratively modify the IGP metric configurations of the digital twin (e.g., emulation model 34) until it is able to converge on an optimal solution. This approach is much better than manual trial and error as it allows an exhaustive search over the parameter space.

The solutions of the present disclosure find the optimal OSPF configuration by optimizing the QoS metrics on the network (e.g., loss, delay, and jitter), rather than only the link utilization metric. The approach described herein significantly reduces the time required to optimize the OSPF configuration on a network and allows the network routes to be optimized based on QoS metrics such as loss, delay, and jitter, rather than only link utilization.

The network optimizer 24 of the present disclosure may be configured as a Network Digital Twin (NDT) with the optimization model 32 and the emulation model 34 for optimizing the OSPF configuration of a network based on QoS metrics. The network optimizer 24 (e.g., NDT) uses an emulator (e.g., Digital Twin (DT), emulation model 34, etc.) that emulates or mirrors a communication network and is capable of optimization (e.g., using the optimization model 32) for optimizing the network and reflecting the behavior of the network. The NDT takes information about the topology (including the OSPF configuration) and traffic flows going through its physical twin (the physical network we are optimizing) and updates the OSPF configuration of its physical twin based on the predicted optimal configuration.

The present disclosure implements the NDT by combining a Graph Neural Network (GNN) (e.g., emulation model 34) with an optimization algorithm designed to minimize a cost function related to the QoS of a physical network. In the present protypes, a RouteNet-F model may be used as the GNN and a genetic algorithm may be used for the optimization algorithm. The use of the optimization model 32 and the emulation model 34 together to form the NDT described herein is unique and is configured to create an optimizable digital twin that can be used for optimizing the QoS of a network via OSPF configuration changes.

The emulation model 34 or other GNN models can be used to predict QoS metrics for a given network and its traffic flows, with a genetic algorithm designed to minimize traffic delays of an OMNeT++ simulated network (the physical twin). FIGS. 7A-7C show how the systems and methods of the present disclosure improve the traffic delays of randomly generated network topologies by optimizing their OSPF configuration.

### RouteNet Model

FIG. 4 is a diagram illustrating an embodiment of a training process 38 for initial training the emulation model 34 shown in FIG. 3. Also, as shown, the emulation model 34 may be configured as a RouteNet model 34-RN (e.g., RouteNet-F), which is a type of GNN model. The training process 38 includes the application of multiple inputs into the RouteNet model 34-RN, such as topology information, route information, and traffic flow information. The topology information may include the arrangement of nodes and links, which may be collected from a real network for providing real-world (supervised) training data. It may be noted that the weights shown with respect to the various links in the topology are not initially known during the initial training process 38, but can be added at a later time once the RouteNet model 34-RN has begun generating outputs from which the weights can be determined. The routes may include different routes from any source node to any destination node. The traffic flow information may include bandwidth (bw), distribution (e.g., Poisson probability distribution), packet sizes, Type of Service (ToS), etc., associated with packet transmission along various routes.

The RouteNet model 34-RN may be configured to emulate a network being monitored and receive input information for creating or training the model. Also, the RouteNet model 34-RN is configured to provide outputs for defining how the emulated network would react to various configurations, traffic conditions, etc. The outputs include QoS data (e.g., delay, jitter, loss, etc.) and average queue occupancy (a link utilization metric). The QoS data and average queue occupancy information can include data for representing each of the various links in the emulated network.

Therefore, according to some embodiments, the emulation model 34 shown in FIG. 3 may be configured as the RouteNet model 34-RN as shown in FIG. 4 for setting up a digital twin (or virtual twin) of a real network. The RouteNet model 34-RN in this respect can accurately react in essentially the same way that the real network would react to various traffic conditions based on the current network status.

RouteNet-Fermi, also known as RouteNet-F, is a GNN model of a communication network. Firstly, it takes as input the topology of the network, which may include a) link bandwidths, b) queuing policy of each interface, c) the number of buffers at each interface, d) the sizes of the buffers, etc. Secondly, it takes as input the traffic flows between each source-destination node and may include a) the average bandwidth used, b) the packet size distribution, c) time distribution, etc. Thirdly, it takes as input the route each traffic flow takes in the topology. The resulting output of RouteNet-F is QoS data, such as the predicted delay, jitter, and loss of each traffic flow. Also, output of RouteNet-F includes average queue occupancy, link utilization, etc.

RouteNet-F is capable of generalizing and accurately predicting QoS metrics on unseen topologies and traffic flows. It serves as an ML-based network model that is capable of predicting QoS metrics much faster than simulation tools such as OMNeT++. RouteNet is also a cost-effective alternative to estimate source-to-destination performance metrics (e.g., delay, jitter, loss) in networks. RouteNet has shown an unprecedented ability to learn and model complex relationships among topology, routing, and input traffic. As a result, it is able to predict network performance with similar accuracy than resource-hungry packet-level simulators even in network scenarios unseen during training.

### RouteNet Model Used in Optimization System

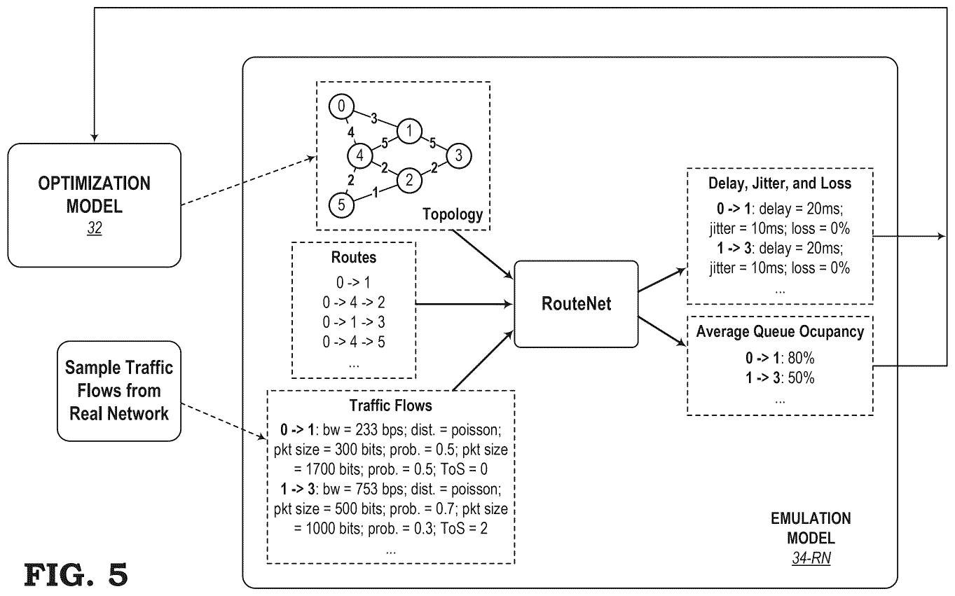

FIG. 5 is a diagram illustrating an example of interactions between the emulation module 34-RN shown in FIG. 4 and the optimization model 32 shown in FIG. 3. Thus, during the iterative procedure between the optimization model 32 and emulation model 34, as suggested with respect to FIG. 3, the optimization model 32 is configured to provide “suggestions” for configuration changes in the network. Also, the optimization model 32 may further provide changes to the routes and traffic flows as applicable. Then, the RouteNet is configured to perform simulations of traffic flows and determine how the network would respond. Outputs are then provided in the form of delay information, jitter information, loss information, and/or link utilization information. The RouteNet model may be configured as a Graph Neural Network (GNN) or other types of Machine Learning (ML) models for IGP optimization.

The output information is then fed back to the optimization model 32, which may be configured to generate Interior Gateway Protocol (IGP) metrics using any suitable algorithms (e.g., genetic algorithm, as described below). Also, the optimization model 32 may be configured to compute routes using any suitable OSPF algorithms (e.g., Dijkstra's algorithm). Also, sample traffic flows may be obtained from the real network and applied to the traffic flow inputs for providing real-world data.

In addition, based on different network configurations (and small modifications to these configurations) for testing the network and further based on how the emulated network responds to test traffic flow conditions, the optimization model 32 is configured to find one or more new network configurations that would be an improvement of the current status of the real network. After multiple iterations, the optimization model 32 can provide recommendations to a network operator for instructing the network operator how the network can be improved or changed towards a more optimized condition.

The proposed NDT architecture for OSPF optimization may use RouteNet-F as the GNN model to predict the QoS metrics of the current traffic flows travelling through the network and couple it with a genetic algorithm to find an OSPF configuration that minimizes a cost function based on the QoS metrics predicted by RouteNet-F. The steps to perform the optimization may include the following steps:

(1) Train RouteNet-F model
a. The model can be pre-trained using offline data either from a real network or from a simulation.
b. Prior to deploying on a real network, the model's predictions can be tested against the network's actual QoS metrics and, if needed, fine-tuned to improve its prediction accuracy for that specific network.

(2) Choose the cost function to be optimized. A common choice is to minimize the maximum or average link utilization, but with RouteNet-F as the network digital twin, constraints on other QoS/performance metrics such as Average or Maximum Loss, Latency, or Jitter, can be considered, or even a combination thereof. That is, in one embodiment, there is a single cost function used for optimization, but this single cost function can be a weighted combination of a plurality of different costs. Advantageously, the NDT approach allows exploration of different configurations and different costs functions, all with the objective of improving the network operation.

(3) Use the Genetic Algorithm and the RouteNet-F model to find the optimal OSPF configuration which minimizes the cost function. The genetic algorithm is initialized by randomly mutating the current OSPF configuration of the network to create a large population of OSPF configuration candidates, where mutations have some probability of occurring on each link in all generations. For each generation:
a. Use the RouteNet-F model to predict the QoS metrics for each OSPF configuration candidate. The configuration with the minimum cost is then recombined with itself to create a new population of candidates.
b. If no candidate from the new generation has a lower cost than the previous generation for some configurable number of generations, our algorithm terminates. The population size and mutation probability as well as our termination criteria are hyper-parameters of the model and may need to be adjusted depending on the network size. The “DT Algorithm” (described below) summarizes the implementation of our NDT for OSPF optimization.

(4) Apply optimized OSPF configuration back into the real network (e.g., by applying the same IGP weights as in the digital twin)
a. At this stage, safe-guards can be put in place to prevent the algorithm from making undesirably large changes all at once. e.g., one could:
   i. have a human validate each recommended change, or
   ii. only allow small changes to the IGP metrics at a time, and gradually approach the optimal configuration rather than changing all at once.

(5) Repeat steps (3) and (4) as needed to ensure that the network remains optimized over time.

### Genetic Algorithm

Genetic Algorithms are search and optimization algorithms, which are inspired by the process of natural selection and the theory of evolution. According to some embodiments, one genetic algorithm that may be used in the present disclosure (e.g., incorporated in the optimization model 32) may include the following seven steps:
1. Initialization where a population of potential solutions for an optimization problem is randomly generated.
2. Evaluation where each solution is evaluated using a fitness function.
3. Selection where solutions with a higher score are selected for “reproduction.”
4. Recombination where a pair or pairs of the highest-scoring solutions are randomly combined to create the new “population.”
5. Mutation where solutions in the new population are randomly modified to prevent the algorithm from converging early.
6. Replacement where new solutions replace the old solutions in the population when creating the next generation.
7. Termination where the algorithm terminates at a specified stopping criterion.

The genetic algorithm used in the optimization model 32 may be simple to implement and may be applicable to any fitness function rather than being specialized, such as heuristic local search techniques. The genetic algorithm may be less likely to get stuck in a local optimum due to the mutation step. In some cases, these algorithms may come at a computationally expensive cost. However, when using a ML digital model, such as RouteNet-F, to provide the metrics for this fitness function, it can be affordable to use genetic algorithms and find a much better solution within a short period than conventional solutions. Therefore, it may be beneficial in some cases to use genetic algorithms for their simplicity and generalization as one goal may be to show how to use an NDT for optimizing OSPF configuration based on QoS metrics. While using a local search technique with heuristics such as those mentioned in Section 2 can improve the time it takes to find a better solution, using a genetic algorithm provides the flexibility of allowing a network operator to choose the fitness function.

### DT Algorithm

The Traffic Engineering Algorithm using a Digital Twin includes:

```
Input: N, M (where N is the real network, and M is the digital model)
Parameter : T generations without improvement before termination, s size of generation
topology ← retrieve topology and features of N
flows ← retrieve estimated distribution of each flow in N
bestConfig ← topology
bestDelay ← predicted average flow delay of N using M
generationsWithoutl mprovement ← 0
while True do
      candidateConfigs ← generate s weight configurations from topology using genetic
algorithm and recompute routes
      predictedDelays ← predict the average flow delay of candidateConf igs using M
generationsW ithoutl mprovement ← generationsWithoutl mprovement + 1
      if min(predictedDelays) ← bestDelay then
            bestDelay ← min(predictedDelays)
            bestConfig  ← candidateConfigs[predictedDelays.index(bestDelay)]
      generationsWithoutImprovement ← 0
      end
      if generationsWithoutImprovement ≥ T then
            break
      end
end
actualDelays ← Apply bestConfig to N and retrieve average flow delays from N
```

### Optimization Process

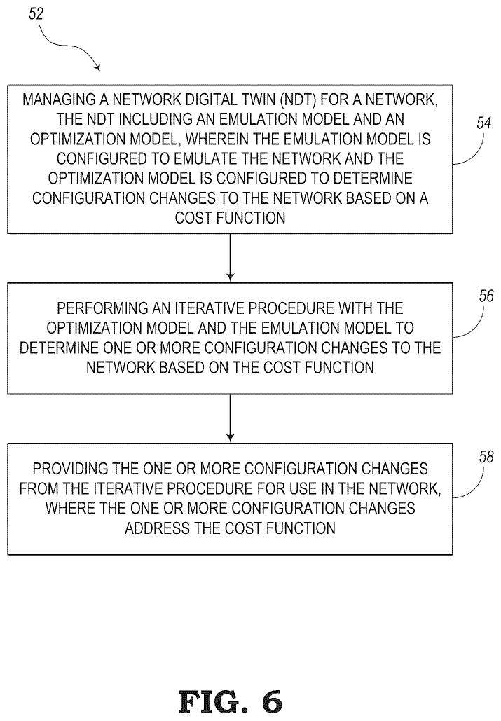

FIG. 6 is a flow diagram illustrating an embodiment of a process 52 for network route optimization using Digital Twin (DT) emulation. The process 52 contemplates implementation as a method having steps, via an apparatus with one or more processing devices configured to implement the steps, and as a non-transitory computer-readable medium storing instructions that, when executed, cause one or more processing devices to implement the steps.

The process 52 includes managing a Network Digital Twin (NDT) for a network, the NDT including an emulation model and an optimization model, wherein the emulation model is configured to emulate the network and the optimization model is configured to determine configuration changes to the network based on a cost function (step 54); performing an iterative procedure with the optimization model and the emulation model to determine one or more configuration changes to the network based on the cost function (step 56); and providing the one or more configuration changes from the iterative procedure for use in the network, where the one or more configuration changes address the cost function (step 58).

The process 52 can include sub-steps for the iterative procedure of imposing network modifications to the emulation model; observing behavior changes in the emulation model in response to the network modifications, and repeating the imposing and observing sub-steps to detect an improved network status until a predetermined stopping criteria. The managing of the NDT can include a step of training the emulation model using topology information, route information, and traffic flow information, for the network, and updating the training responsive to any implementation of the one or more configuration changes in the network. The steps can further include automatically causing implementation of the one or more configuration changes in the network.

The emulation model can include a Graph Neural Network (GNN) and the optimization model includes a genetic algorithm. The optimization model can include a genetic algorithm that includes the steps of randomly generating a population of potential solutions for optimizing traffic flow, using a fitness function, based on the cost function to evaluate a score for each potential solution, selecting the potential solutions with the highest scores, randomly combining one or more pairs of potential solutions with the highest scores to create a new population, randomly modifying the new population to produce modified solutions, replacing old solutions with the modified solutions, and repeating until a predetermined stopping criteria is reached.

The cost function can be based on one of latency, loss, jitter, link utilization, cost, security, and a combination thereof. The cost function can be based on a plurality of factors combined in a weighted manner to provide a single cost function for the optimization model. The one or more configuration changes can each include one of Open Shortest Path First (OSPF) configuration, Traffic Engineering (TE) tunnel configuration, Border Gateway Protocol (BGP) configuration, link coloring configuration, Resource Reservation Protocol-Traffic Engineering (RSVP-TE) configuration, Multiprotocol Label Switching (MPLS) configuration, Quality of Service (QOS) configuration, and Segment routing configuration.

### Test Results Using Simulation

FIGS. 7A-7C are graphs showing results of testing the performance of the network optimizer 24 shown in FIG. 2. The graphs show a Cumulative Distribution Function (CDF) of the Mean Delay in a simulated network before and after OSPF optimization using the network optimizer or NDT. To demonstrate the feasibility of this approach, the test was set up using a different number of nodes and using an OMNeT++ network simulation to act as a “physical” network. The test was applied to the digital twin to optimize the OSPF configurations of the simulation. In the prototype, the tests used the average traffic delay in the network as the cost function. The genetic algorithm was configured to produce 2000 configurations per generation, with a 20% probability of mutating a given link. The genetic algorithm was configured to terminate after four generations (e.g., iterations) of no improvement to the cost. It can be understood from the graphs of FIGS. 7A-7C that the embodiments of the present disclosure are able to improve the traffic delays after its OSPF configuration has been optimized.

To evaluate the various implementations described herein, the test includes three topologies, a 6-node topology (FIG. 7A), a 10-node topology (FIG. 7B), and a 20-node topology (FIG. 7C) with randomly generated Poisson traffic flows ranging from 200 bits per second to 2000 bits per second for each source-destination pair. The link capacity of each link was set to 100 kbps and all queuing policies were set to FIFO with a single 32 kbits queue. The test used the RouteNet-F model trained on the fat-tree N=128 dataset provided in the RouteNet-F paper. For the real networks (i.e., the “physical” twin), the tests used the same OMNeT++simulation used to train RouteNet-F. The OSPF weights were also randomly initialized to either have a weight of 5 or 1 in the simulated networks. The genetic algorithm was also constrained to this set of weights to minimize its search space.

### Additional Implementations

The present disclosure combines the RouteNet-F ML model and Genetic Algorithm in a single optimization system (i.e., the network optimizer 24). Conventional systems do not suggest such a combination for optimizing a network for data traffic flow while working in parallel with a digital twin. Therefore, the embodiments described herein are configured to create a system which uses a network digital twin for route optimization in IP networks via OSPF metric configuration search.

Also, the embodiments are found to be novel with respect to providing a network digital twin that includes a GNN-based ML model which takes as input the physical network topology, routes, and traffic flows, and outputs metrics required to compute the cost function, such as QoS metrics. It has been found that a useful example of a model that fulfills this criteria is RouteNet-F.

The network optimizer 24 (e.g., including at least one or both of the optimization model 32 and the emulation model 34) is configured to optimize (i.e., improve) some cost function. For example, optimizing a cost function may include a) reducing a link utilization value of the most utilized link in the topology, b) reducing an average link utilization of the links, c) reducing a latency (or delay) of a link with the most latency in the topology, d) reducing an average latency (or delay) of the links, e) reducing a loss of a link having the most loss in the topology, f) reducing an average loss throughout the topology, g) reducing jitter of a link having the most jitter in the topology, h) reducing an average jitter of the links, etc. Furthermore, in some embodiments, the optimization (or improvement) may include a combination of two or more of the above cost functions. For example, each cost function may be associated with a weight function (or cost) that can be used to influence the total cost in different degrees. In some cases, the cost function may be a function of both a link utilization component and a QoS component (e.g., delay, loss, jitter, etc.). The network optimizer 24, in some embodiments, can use ML to develop a complex cost function that simultaneously optimizes multiple metrics.

OSPF configuration optimization is the process of setting the Interior Gateway Protocol (IGP) metric of each link in the network to optimize for some metric of the network, such as maximum link utilization, average End-to-End (E2E) loss, etc. The IGP metric of a link in the OSPF protocol, also referred to as the weight of the link, is the cost of taking this link. Traffic flowing to a destination node from a source node is routed through the minimal-cost path.

Conventional methods typically only optimize for bottleneck link utilization or average link utilization or for energy efficiency. One method includes Service-Layer Agreement (SLA) requirements and performance under link failures in addition to link utilization. The problem with finding an OSPF configuration that minimizes the bottleneck link utilization for a given topology and a set of traffic flows/demands is a NP-hard problem. Conventional methods either use a neighborhood search technique using a set of heuristics, or a Machine Learning (ML) approach. As mentioned below, the state-of-the-art OSPF optimization for link utilization starts with the first method, IGP Weight Optimization, a technique that uses local search heuristics to find the optimal OSPF configuration.

IGP Weight Optimization was proposed by Fortz and Thorup. It takes in the topology of the network, the associated weight and capacity of each link in the network, and the bandwidth demand between each source-destination node pair. It then uses a local search algorithm to find a weight configuration that minimizes the total utilization cost of all links in the network. They define the utilization cost of a link as a function that scales exponentially with the utilization percentage of the link.

The neighbors of the current candidate OSPF configuration of a given network topology are defined as the following:
Single link weight change.
Splitting traffic to a destination node evenly across a random number of neighbors at a transit node.

To prevent looping through visited OSPF configurations, they maintain a hash table of all visited OSPF configurations. This algorithm can be terminated at any point during the search to find a better OSPF configuration; however, it is not guaranteed that it will find the global optimum configuration. Rusek et al. recently reproduced the results of Fortz and Thorup to compare IGP weight optimization to their ML approach. They show that it can find significantly better OSPF configurations that minimize the maximum link utilization in a short period of time on four real-world topologies (i.e., Janos-US, GEANT, Nobel-Germany, and COST266).

Dynamic IGP Weight Optimization was proposed by Brun and Garcia. It uses a very similar local search algorithm as IGP Weight Optimization with some slight modifications to the neighborhood space to find an OSPF configuration that minimizes the maximally utilized link. The neighbors of a candidate OSPF configuration are defined as the following:
A single link weight change that deviates a traffic flow from the link if the traffic flow has multiple minimum cost paths.
A single link weight change that introduces an alternative path for a traffic flow (introduces a new minimum cost path).

In addition to those differences, Dynamic IGP Weight Optimization estimates the source-destination demand matrix from a time series of link demands rather than having prior knowledge of those demands. The resulting OSPF configuration recommendation is then based on the worst-case demand scenario out of the set of possible demands inferred from the link demands. However, this makes it much more computationally expensive than IGP Weight Optimization.

Routing By Back-propagation (RBB) is the latest OSPF optimization technique proposed by Rusek et al. It makes use of a GNN model that is trained to approximate the minimum cost path between each source-destination node pair (i.e., Dijkstra's algorithm) for a given topology with a set of link weights. This pre-trained GNN is then used along with the capacity of each link and the traffic demands between each source-destination pair to backpropagate the input IGP weights of each link to minimize the maximally utilized link. This method is much faster than the aforementioned techniques, with the authors reporting an average 25% reduction in the maximally utilized link utilization from the default OSPF configuration after three back-propagation steps.

While the methods we listed in this section can find much better OSPF configurations in a short period, none of them consider any variable beyond link utilization for OSPF configuration. The following compares the network optimizer 24 (e.g., “Network Digital Twin” or NDT) for OSPF optimization with some of the related work, which may also be used in the NDT implementations.

In FIGS. 7A-7C, the plots of the Cumulative Distribution Function (CDF) of the traffic flow delays going through each of our simulated topologies show the results before and after optimization. The delays were obtained from the OMNeT++simulated topology (i.e., our “network physical twin”) in the experiments. The results show that the techniques of the present disclosure successfully reduced the average traffic delay in all the randomly generated networks. The systems and methods of the present disclosure shift the distribution of traffic delays closer to lower delays and consistently reduce the maximum traffic delay in the network in all our topologies. The NDTs of the present disclosure found a solution within 5 minutes on a GTX1080Ti GPU and an Intel i7 7700k CPU. These promising results indicate that the NDT for OSPF optimization based on QoS metrics, based on the embodiments described herein, is viable and more importantly, allows for optimization for other QoS metrics beyond delay with ease. A network operator can optimize for other metrics by simply changing the fitness function. For instance, to optimize traffic loss or link utilization, the network operator can change the fitness function to be negatively proportional to the maximum traffic loss or the maximum link utilization in the network without modifying the architecture.

Coupling the present NDT architecture for optimizing a network with a smarter optimization algorithm and a desired optimization criteria opens the door for new methods of automating TE and network optimization. The embodiments described herein show how one can use this NDT architecture to perform OSPF optimization based on QoS metrics. The present NDT was able to find OSPF configurations that significantly reduced the traffic delays in the twinned networks. In some cases, the genetic algorithm might be limited to a set of two weights and may take longer to terminate when the set of weights is large as it increases the search space. In further embodiments, perhaps a better termination criterion in this case would be the percentage improvement in the last t generations.

Using a smarter optimization algorithm, such as a local search heuristic, can also improve performance and the speed of finding a solution. However, the genetic algorithm provides a baseline implementation that can be extended further. For example, some additional embodiments may include comparing the present NDT for OSPF optimization to the state-of-the art OSPF optimization techniques using the average traffic delay, maximum link utilization and the time to arrive at a solution. Moreover, applying this architecture to a real network rather than a simulated network would show how well the NDT for OSPF optimization performs in practice and if changes are required to adjust for a real network.

The emulation model 34 or “Digital Twin” is a digital representation of the real network 30. Such an emulation model is not a simulator, per se, but instead provides additional Al or ML techniques for predicting how the real network 30 might react to certain unknown or previously undefined network conditions. Thus, the digital twin is supposed to react the same way that the thing in real life would react. Taking an airplane as an example, a digital twin of the airplane would be able to mimic the physics calculations and then apply some condition (e.g., turbulence) as input. The DT may then react (e.g., rock, vibrate, etc.) and may include automatic compensation (e.g., leveling out, pitch compensation, roll compensation, etc.) as a real airplane would.

In the field of networking, however, inputs may include traffic conditions, simulated faults, data flow congestion, over-utilization of some links, QoS issues (e.g., delay, loss, jitter, etc.), or other issues. Then, the DT can be configured to output changes to compensate for these simulated conditions, such as by redirecting traffic through different routes (e.g., different path of links), avoiding certain faulty nodes or links, etc. By providing continuous updates from the real network 30 to the network optimizer 24, the network optimizer 24 can perform the iterative process between the optimization model 32 and the emulation model 34 to determine an improved configuration. Then, this improved configured may be communicated to the network operator, who can then manually make changes in the real network 30 as needed to optimize (improve) the network and/or some feedback may be provided directly to the real network 30 itself to automatically configure the network according to the optimization strategies determined by providing various simulation events on the emulation model 34.

In this way, the DT (e.g., emulation model 34) is configured to react the same way that reality would. However, in the current embodiments, this is done in this exercise where the real network 30 itself is also changed. The systems and methods of the present disclosure are configured to tweak the DT first, find the best minor adjustments that can be made for improving the network, and then tweaking the real network. The network optimizer 24 is configured to discover how the modified network will behave and then apply this to the network 30. Of course, this can be performed in a continuous manner to continually tweak the network 30 in real time. The Al (e.g., ML, Reinforcement Learning, etc.) in the network optimizer 24 is configured to step the network in the direction of the goal of optimization, using these offline (e.g., lab) calculations. And in various embodiments, it can optimize for various metrics, such as latency, or any one or multiple other metrics that the network operator can choose from.

Any suitable simulator implemented in hardware and/or software may be used to mimic conditions that can be applied to the DT for testing. In some cases, an OMNeT++ simulation software product can be used, which is configured to perform packet level simulation of networks. It basically uses the math behind queuing theory and other constructs to have a low-level accurate representation of a packet level simulation.

It should be noted, of course, that optimization may include reducing negative factors (e.g., over-utilization of network resources, loss, latency, etc.) and may also include increasing positive factors (e.g., energy efficiency, transmission speeds, lower financial costs, etc.). The optimization model 32 tries different candidate configurations to predict the delay, loss, jitter, etc. for each of those scenarios and repeats the testing for multiple iterations (or genetic generations) in a back and forth manner for a certain amount of time until it is able to converge on a solution. Within that timeframe, the optimal configuration of the network that gives the best results, based on the criteria fed to the optimization model 32 regarding the various cost function or cost functions that the network operator may wish to optimize (e.g., minimum delay, minimum loss, shortest path, etc.). Upon convergence (or best solution under a given time constraint), the network optimizer 24 sends that new configuration back into the real network 30. Based on the ML predictive nature of the network optimizer 24, the predicted delay, loss, jitter, etc. will likely closely match what happens in the real network 30.

In a sense, the optimization model 32 may be considered to include a “search algorithm,” which may include a ML model that attempts multiple possible solutions, searches for best solutions, and then can improve the operation of the network.

Also, the network optimizer 24 is configured to be trained to recognize how a network can be improved, using various strategies. Some may not necessarily be intuitive to the average person. Also, by streamlining the searching phase and attempting various candidate configurations in a controlled manner, as opposed to brute force, the network optimizer 24 is configured to find useful improvements in a much quicker time. For instance, if simple brute force strategies were used, the procedure would be very slow. On the other hand, the network optimizer 24 can gradually approach the optimal solution in a fraction of the time. Also, with training and retraining, the ML models of the network optimizer 24 are configured to avoid other strategies that may be unnecessarily time-consuming, such as using exhaustive set of scenarios.

### CONCLUSION

It will be appreciated that some embodiments described herein may include one or more generic or specialized processors (“one or more processors”) such as microprocessors; central processing units (CPUs); digital signal processors (DSPs): customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a read-only memory (ROM), a programmable read-only memory (PROM), an erasable programmable read-only memory (EPROM), an electrically erasable programmable read-only memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Further, the various elements, operations, steps, methods, processes, algorithms, functions, techniques, modules, circuits, etc. described herein contemplate use in any and all combinations with one another, including individually as well as combinations of less than all of the various elements, operations, steps, methods, processes, algorithms, functions, techniques, modules, circuits, etc.

What is claimed is:

1. A non-transitory computer-readable medium configured to store computer logic having instructions that, when executed, cause one or more processing devices to perform steps of:
managing a Network Digital Twin (NDT) for a network, the NDT including an emulation model and an optimization model, wherein the emulation model is configured to emulate the network and the optimization model is configured to determine configuration changes to the network based on a cost function;
performing an iterative procedure with the optimization model and the emulation model to determine one or more configuration changes to the network based on the cost function; and
providing the one or more configuration changes from the iterative procedure for use in the network, where the one or more configuration changes address the cost function.

2. The non-transitory computer-readable medium of claim 1, wherein the steps further include sub-steps for the iterative procedure of
imposing network modifications to the emulation model;
observing behavior changes in the emulation model in response to the network modifications, and
repeating the imposing and observing sub-steps to detect an improved network status until a predetermined stopping criteria.

3. The non-transitory computer-readable medium of claim 1, wherein the managing the NDT includes a step of
training the emulation model using topology information, route information, and traffic flow information, for the network, and updating the training responsive to any implementation of the one or more configuration changes in the network.

4. The non-transitory computer-readable medium of claim 1, wherein the steps further include
automatically causing implementation of the one or more configuration changes in the network.

5. The non-transitory computer-readable medium of claim 1, wherein the emulation model includes a Graph Neural Network (GNN) and the optimization model includes a genetic algorithm.

6. The non-transitory computer-readable medium of claim 1, wherein the optimization model includes a genetic algorithm that includes the steps of
randomly generating a population of potential solutions for optimizing traffic flow,
using a fitness function, based on the cost function to evaluate a score for each potential solution,
selecting the potential solutions with the highest scores,
randomly combining one or more pairs of potential solutions with the highest scores to create a new population,
randomly modifying the new population to produce modified solutions,
replacing old solutions with the modified solutions, and
repeating until a predetermined stopping criteria is reached.

7. The non-transitory computer-readable medium of claim 1, wherein the cost function is based on one of latency, loss, jitter, link utilization, cost, security, and a combination thereof.

8. The non-transitory computer-readable medium of claim 1, wherein the cost function is based on a plurality of factors combined in a weighted manner to provide a single cost function for the optimization model.

9. The non-transitory computer-readable medium of claim 1, wherein the one or more configuration changes each include one of Open Shortest Path First (OSPF) configuration, Intermediate System-Intermediate System (IS-IS) configuration, Traffic Engineering (TE) tunnel configuration, Border Gateway Protocol (BGP) configuration, link coloring configuration, Resource Reservation Protocol-Traffic Engineering (RSVP-TE) configuration, Multiprotocol Label Switching (MPLS) configuration, Quality of Service (QOS) configuration, and Segment routing configuration.

10. A method comprising steps of:
managing a Network Digital Twin (NDT) for a network, the NDT including an emulation model and an optimization model, wherein the emulation model is configured to emulate the network and the optimization model is configured to determine configuration changes to the network based on a cost function;
performing an iterative procedure with the optimization model and the emulation model to determine one or more configuration changes to the network based on the cost function; and
providing the one or more configuration changes from the iterative procedure for use in the network, where the one or more configuration changes address the cost function.

11. The method of claim 10, wherein the steps further include sub-steps for the iterative procedure of
imposing network modifications to the emulation model;
observing behavior changes in the emulation model in response to the network modifications, and
repeating the imposing and observing sub-steps to detect an improved network status until a predetermined stopping criteria.

12. The method of claim 10, wherein the managing the NDT includes a step of
training the emulation model using topology information, route information, and traffic flow information, for the network, and updating the training responsive to any implementation of the one or more configuration changes in the network.

13. The method of claim 10, wherein the steps further include
automatically causing implementation of the one or more configuration changes in the network.

14. The method of claim 10, wherein the emulation model includes a Graph Neural Network (GNN) and the optimization model includes a genetic algorithm.

15. The method of claim 10, wherein the optimization model includes a genetic algorithm that includes the steps of
randomly generating a population of potential solutions for optimizing traffic flow,
using a fitness function, based on the cost function to evaluate a score for each potential solution,
selecting the potential solutions with the highest scores,
randomly combining one or more pairs of potential solutions with the highest scores to create a new population,
randomly modifying the new population to produce modified solutions,
replacing old solutions with the modified solutions, and
repeating until a predetermined stopping criteria is reached.

16. The method of claim 10, wherein the cost function is based on one of latency, loss, jitter, link utilization, cost, security, and a combination thereof.

17. The method of claim 10, wherein the cost function is based on a plurality of factors combined in a weighted manner to provide a single cost function for the optimization model.

18. The method of claim 10, wherein the one or more configuration changes each include one of Open Shortest Path First (OSPF) configuration, Intermediate System-Intermediate System (IS-IS) configuration, Traffic Engineering (TE) tunnel configuration, Border Gateway Protocol (BGP) configuration, link coloring configuration, Resource Reservation Protocol-Traffic Engineering (RSVP-TE) configuration, Multiprotocol Label Switching (MPLS) configuration, Quality of Service (QOS) configuration, and Segment routing configuration.

19. An apparatus comprising:
a processing device; and
a memory device configured to store a computer program having instructions that, when executed, enable the processing device to perform steps of
manage a Network Digital Twin (NDT) for a network, the NDT including an emulation model and an optimization model, wherein the emulation model is configured to emulate the network and the optimization model is configured to determine configuration changes to the network based on a cost function,
perform an iterative procedure with the optimization model and the emulation model to determine one or more configuration changes to the network based on the cost function, and
provide the one or more configuration changes from the iterative procedure for use in the network, where the one or more configuration changes address the cost function.

20. The apparatus of claim 19, wherein the apparatus is one of a Network Management System (NMS), an Element Management System (EMS), a network planning system, a Software Defined Networking (SDN) controller, an SDN application, or an orchestrator.
